(19) United States
(12) Patent Application Publication
(10) Pub. No.: US 2003/0108329 A1
(43) Pub. Date: Jun. 12, 2003

(54) Advertising method and system

(76) Inventors: Meric Adriansen, Union City, NJ (US); Michael P. Szymanski, Orchard Park, NY (US)

Correspondence Address: BROWN, RAYSMAN, MILLSTEIN, FELDER & STEINER LLP, 900 THIRD AVENUE, NEW YORK, NY, 10022, US

(21) Appl. No.: 10/016,018

(22) Filed: Dec. 12, 2001

(51) Int. Cl. H04N 5/93; G11B 27/00

(52) U.S. Cl. 386/52; 386/53

(57) ABSTRACT

An advertising method and system is disclosed in which a picture or video of a member of the public is superimposed on a picture or video advertising a product or service. A picture or video of a person is taken and input into an image processing system in which the picture or video of the person is superimposed onto a picture or video advertising a product or service to generate a composite picture or video which is then output to a display for display in a public place.

### FIELD OF THE INVENTION

The present invention generally relates to an advertising method and system which enables a picture or video of a person to be superimposed on a picture or video advertising a product or service.

### BACKGROUND OF THE INVENTION

Advertisers are continuously trying to increase the public awareness of products and services. In places such as Times Square in New York a plethora of large advertising displays vie for public attention. This provides the problem of how to make an advertising display capture the attention of the public so that the advertising message can get through to the public.

### SUMMARY OF THE INVENTION

The present invention addresses this problem by allowing a picture or video of a member of the public to be superimposed on or mixed in a picture or video advertising a product. In this way the member of the public and any friends or acquaintances will pay attention to the displayed advertisement while the persons image is displayed in a public place. Such a technique is particularly suited to area where there are a large number of advertising displays vying for the attention of the public such as in Times Square in New York.

In one embodiment the picture or video of the person is edited to remove the background before superimposition on a picture or video advertising a product or service.

In an embodiment of the present invention a picture is taken of the person in the vicinity of the advertising display. This ensures that the person is in the vicinity of the display to view the resultant composite advertisement display.

In a further embodiment of the present invention, the picture or video of the person is superimposed onto a video advertising a product or service in a predetermined position in the video such that the position tracks a position relative to a moving object in the video. Thus in this way the picture or video of the person can be made to integrate into the video advertisement so that the person becomes part of the advertising message. This has a more powerful effect than keeping the image of the person static in a video clip.

In a further embodiment of the present invention, a library of pictures or video recordings advertising products or services is provided and one of the library of pictures or video recordings is selected for the picture or video of the person to be superimposed onto to generate a composite picture or video. This enables the displayed adverts to be varied.

In another embodiment of the present invention, the picture or video of the person is edited so as to only include the head of the person, and the head is superimposed onto the picture or video advertising a product or service in a position of an original head and with corresponding dimensions so as to replace the original head with the head of the person. This provides for a close integration of the person in the advertising image thus increasing its impact.

In one embodiment of the present invention, the displayed composite picture or video is made available to the person. This enables the person to have a memento of the occasion and further increases the persons (and their friend and colleagues) exposure to the advertising message. The displayed composite picture can be stored so as to be accessible over the Internet to the person. Alternatively or in addition, a copy of the composite picture of video can be sent to an email address provided by the person.

In one embodiment of the present invention, personal information can be obtained from the person and stored. This information can be used for marketing at a later date.

In a further embodiment of the present invention, a picture or video of the display and its surroundings is taken during the display of the composite picture of video and a copy is provided to the person. This further enhances the prestige of the event since the person has an image proving that their picture was displayed on a large display in a public place such as Times Square. The picture or video of the display and its surroundings can be made available to the person over the Internet. Alternatively or in addition, the picture or video of the display and its surroundings can be sent to an email address provided by the person.

In one embodiment of the present invention, the picture or video of the person is manually reviewed to approve the picture or video for superimposition. This can be used for safety to ensure that no undesirable images are included in the advertising display.

In a further embodiment of the present invention, a plurality of pictures or videos of persons are stored, a library of pictures or video recordings advertising products or services are provided, and one of the library of pictures or video recordings is selected and one of the pictures or videos of the persons is selected for superimposition to generate a composite picture or video for display. The selections can be made in accordance with a predetermined schedule so that the composite pictures or videos are displayed in accordance with the schedule. This provides control and allows for the setting up of an advertising program using the display and incorporating images of members of the public. The schedule preferably ensures that the images of the members of the public takes place soon after their picture is taken so that they are still in the vicinity of the display at the time their image is displayed.

In another embodiment of the present invention, a second library of pictures or videos advertising products or services is provided, and the schedule includes pictures or videos in the second library so that the pictures or videos are displayed in accordance with the schedule. This enable pre-recorded advertising images without including images of members of the public to be included in the display advertising schedule.

### BRIEF DESCRIPTION OF THE DRAWINGS

Embodiments of the present invention will now be described with reference to the accompanying drawings, in which:

FIG. 1 is a schematic diagram of an advertising system in accordance with an embodiment of the present invention;

FIGS. 2a to 2d are illustrations of sequences of images from an animation displayed on the display in the embodiment of FIG. 1;

FIG. 3 is a schematic diagram of the kiosk computer system in the embodiment of FIG. 1;

FIG. 4 is a schematic diagram of the display control system in the embodiment of FIG. 1;

FIG. 5 is a flow diagram of the method of operation of the kiosk computer system in accordance with the embodiment of the present invention of FIG. 1; and

FIGS. 6a and 6bare a flow diagram of the method of operation of the display computer system in accordance with the embodiment of the present invention of FIG. 1.

### DESCRIPTION OF PREFERRED EMBODIMENTS

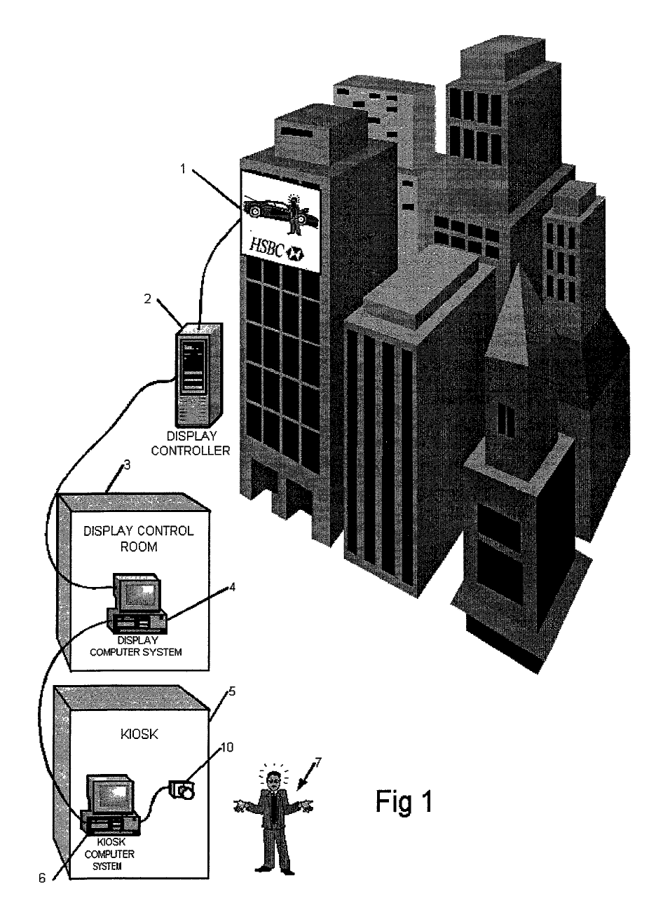

An embodiment of the present invention is illustrated schematically in FIG. 1. A large display 1 is provided in a public place which in this example is on the side of a building. The display 1 displays video clips advertising products or services. Such an arrangement is common in the prior art e.g. in Times Square New York. A display controller 2 is provided for controlling the display to display the video clips received as a video VGA type signal by the display controller 2. In a display control room 3 a display computer system 4 is provided to generate the VGA type signals for the display controller 2. A kiosk which is accessible to the public is arranged in the vicinity of the display 1 so that members of the public 7 can enter to have their picture taken by a digital camera 10 connected to a kiosk computer system 6 so that their picture will appear on the display 1 superimposed into the advertisement. The member of the public 7 is photographed in a booth with a chroma green background to facilitate the removal of the background during the processing of the digital image in the display processing system.

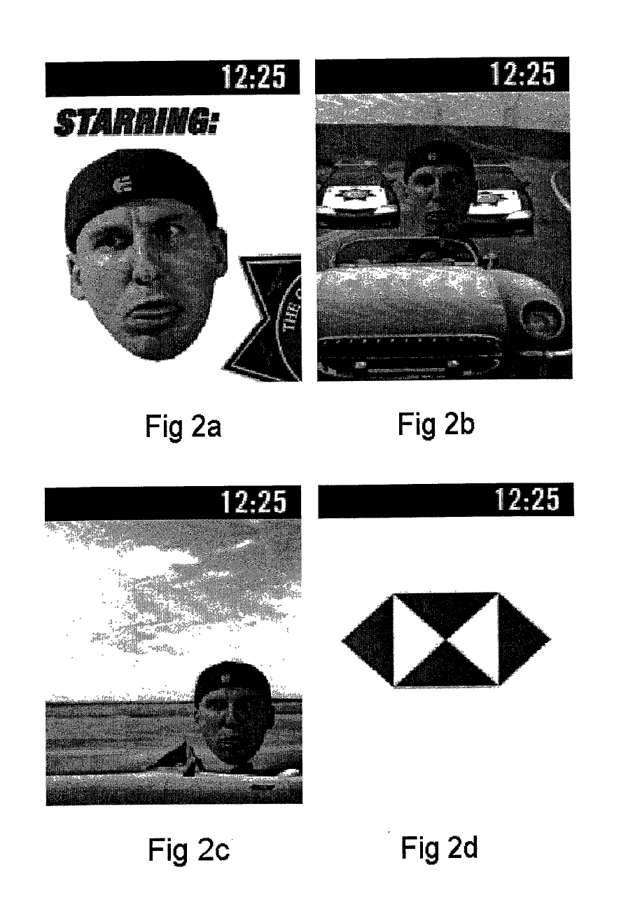

FIGS. 2a to 2d are illustrations of a sequence of images from an animation that is displayed on the display 1. It can be seen that the head of a member of the public is superimposed on an animation that advertises a service. The superimposed head follows a path in the animation that includes the position of a head of a driver of a car.

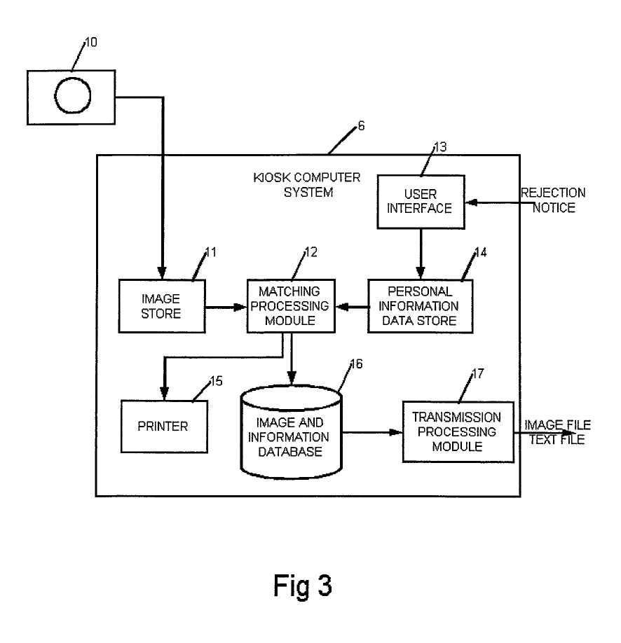

FIG. 3 illustrates the kiosk computer system 6 in more detail. The digital pictures taken by the digital camera 10 are input into the kiosk computer system 6 so as to be stored in an image store 11. In addition to inputting the digital picture of the person, personal information is taken from the person and entered into the computer system using a user interface 13 e.g. a display and pointing device and this is stored in a personal information data store 14. A matching processing module 12 is provided to identify any image data and personal data and to match them to form a personal record in a database 16. Also an ID and information is printed by printer 15. The ID is unique to the person and enables them to access a copy of the video advertising clip in which they are superimposed in due course. The printed information informs them how to access the video clip which, in this embodiment will be made available on a web site which can also carry further advertising material thereby exposing the member of the public to further advertising messages which can be specifically tailored to the person using the personal information.

Periodically, or whenever there is a new record in the database 16, a transmission processing module 17 accesses the database 16 and forms an image file e.g. a JPG file having the ID as the file name for future identification purposes, and a text file e.g. a TXT file carrying the personal information and having the ID as the file name for future identification purposes. These files are then transmitted by the transmission processing module 17 to the display computer system 4.

The user interface 13 can also receive a rejection notice from the display computer system 4 when a picture of a person is rejected because. it is considered unsuitable for display. This avoids obscene or insulting images from being displayed and enables an operator to be warned, if not aware, that unsuitable pictures are being taken using the digital camera 10.

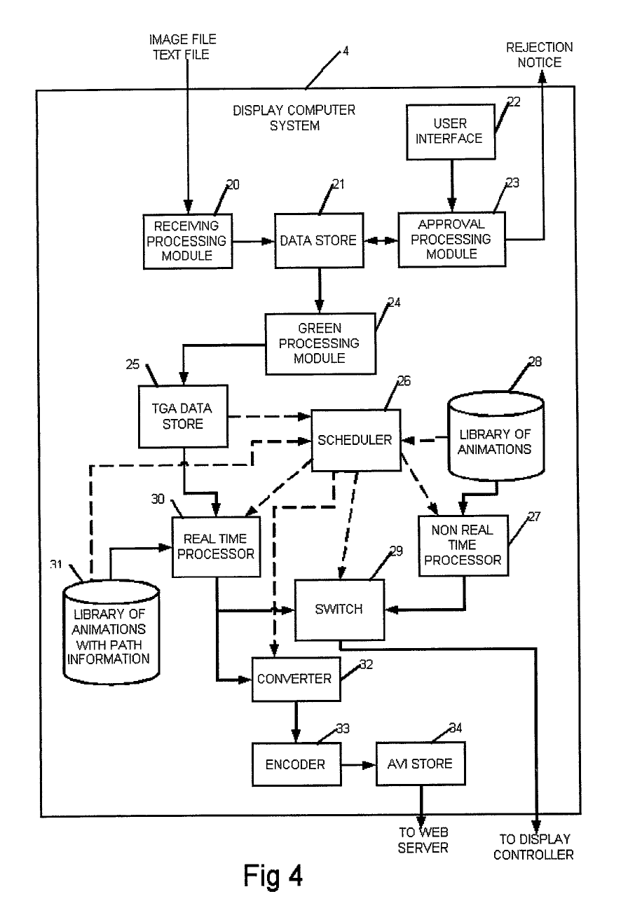

FIG. 4 illustrates the display computer system 4 in more detail. Image files and associated text files are received from the kiosk computer system 6 by a receiving processing module 20. The files are stored in a data store 21. A user interface 22 e.g. a display and a pointing device is provided to allow a user to display, review and approve or disapprove the received image data. An approval processing module 23 provides the approval capability and is coupled to the user interface 22 and the data store 21. The approval processing module 23 can also output a rejection notice for transmission back to the kiosk computer system when an image is not approved i.e. it is considered unsuitable for display e.g. it is obscene or insulting. If an image is approved, it is flagged as such in the data store 21.

A green processing module 24 is coupled to the data store 21 to read and process any image files that have been flagged as approved. The green processing module 24 performs background subtraction which is termed in the art ‘green processing’. The green background is effectively removed by the process. Such a process is for example a standard feature of the software package Photoshop. The processing can also select a region of the image so that only a part of the person is retained in the image e.g. the face or head. The result of the ‘green processing’ by the green processing module 24 is a ‘Targa’ file (a TGA file) which has a key signal in it denoting a transparent background. A TGA store 25 is provided to store the TGA files.

A scheduler 26 is provided to schedule the order of display of video clips on the display 1. The schedule 26 allows a controller of the system to schedule certain video clips for certain times of the day. A library of video clips or animations 28 is provided for display without the addition or superposition of an image of a member of the public 7. The library of video clips or animations 28 is accessible by a non-real-time processor 27 to render them and output a VGA type signal. A switch 29 is controlled by the scheduler 26 to switch the VGA type signal for output to the display controller 2. A library of video clips or animations 31 is provided which includes path information designating the position throughout the video clip of animation where the image of the person is to be superimposed. A real-time processor 30 is controlled by the scheduler 26 to perform the superposition by accessing the TGA files in the TGA data store 25 and the video clip or animation designated by the scheduler 26 to generate a VGA type signal. The switch 29 is controlled by the scheduler 26 to switch the VGA type signal for output to the display controller 2. Thus in this way, the scheduler is able to control the advertisement display schedule to display pre-rendered animations or video clips at scheduled times and animations or video clips with the persons image superimposed at scheduled times.

The superimposition process performed by the real-time processor 30 allows the processed image to be overlaid on an appropriate part of the video image. For example the face of a person in the background video clip or animation can be replaced by the face of the person and can be made to follow the position of the background face by following the predetermined path associated with the video clip or animation.

The pre-rendered video clips or animations can be standard video filed such as AVI files of MPG files. The non-real-time processor 27 processes these to form the VGA type signal for output to the display controller 2.

The display computer system 4 also includes a VGA to video converter 32 coupled to the output of the real-time processor 30 and under the control of the scheduler 26 to convert the real-time generated VGA type output to video. An encoder 33 is coupled to the converter 32 to encode the video as a digital file format such as AVI which is then stored in an AVI store 34. The AVI files in the AVI store 34 can be accessed by the person. In this embodiment the AVI store 34 is accessible by a web server to which a person can direct their web browser to gain access. The web server can also access the personal information which can be stored in association with the AVI files. The files can be stored identified by the ID assigned to the person. The person can access the AVI file by inputting the ID assigned to them on the web site. The web site can then use this to tailor the web page to the person e.g. by including advertisements targeted at the person based on the personal information.

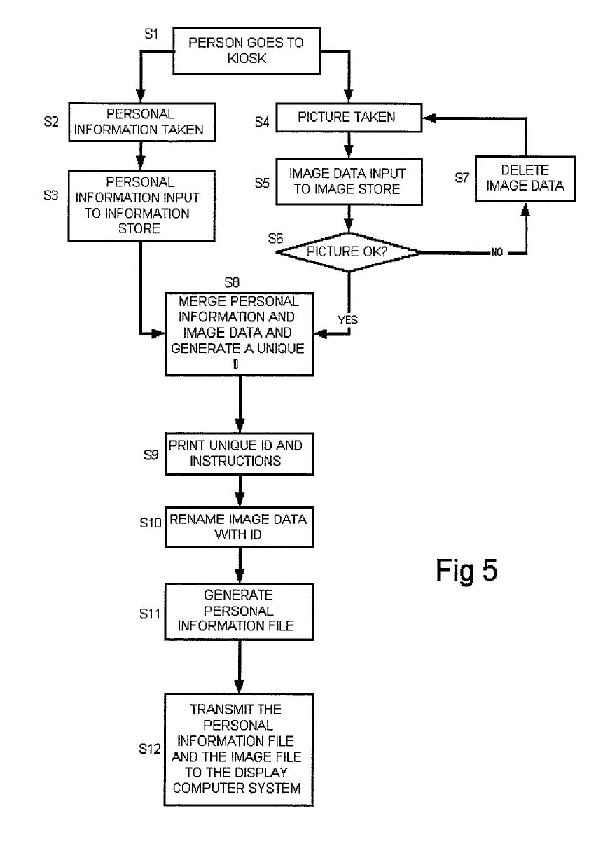

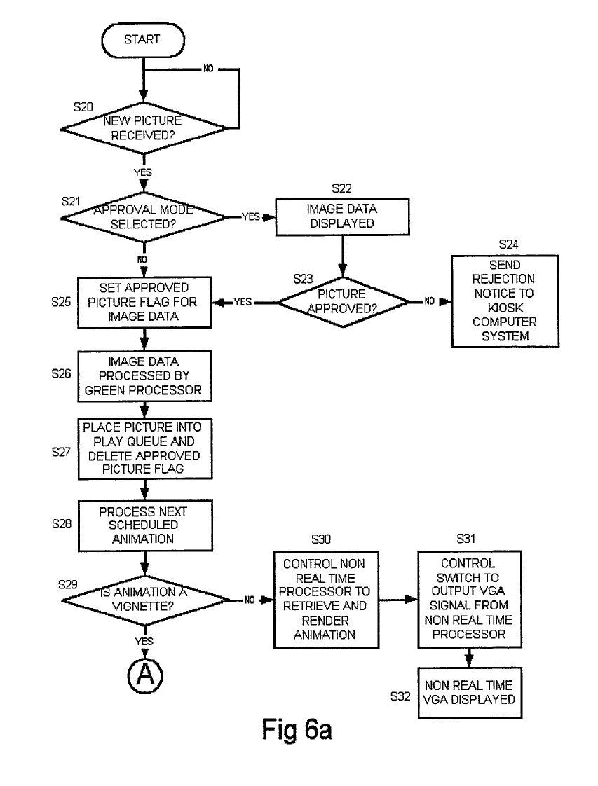

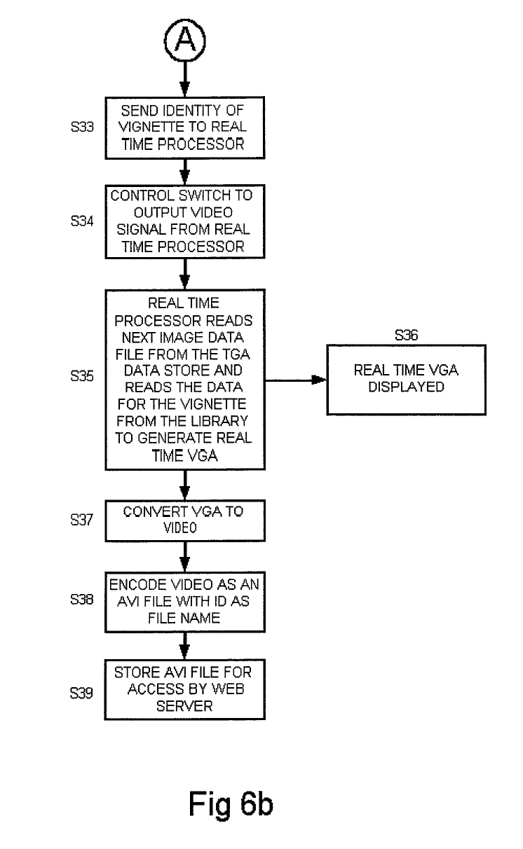

The operation of the system will now be described with reference to the flow diagrams of FIGS. 5, 6a and 6b in which FIG. 5 illustrates the processes taking place in the kiosk 5 and FIGS. 6a and 6b illustrate the processes taking place in the display control room 3.

When a person enters the kiosk 5 (step S1 in FIG. 5), they are asked personal information such as name, address, age etc (step S2). This information is input into the information store 14 (step S3) by use of the user interface 13. This can for example take place while the person is waiting in a queue to have their picture taken. This information can be used for marketing purposes by the operator of the advertising system. The person then has their picture taken (step S4) by the digital camera 10. An image data file is input from the camera 10 to the image store 11. The picture can be viewed on the user interface 13 to confirm that it is satisfactory (step S6). If it is not, the file can be deleted (step S7) and the person's picture can be retaken (step S4). If the picture is satisfactory, the matching processing module 12 merges (matches) the image data files in the image store 11 with the personal information in the personal information data store 14 and a unique user ID is assigned for the data (step S8). This forms a unique record in the image and information database 16 for the person. The printer 15 then prints the persons unique ID and instructions for the person (step S9). The information is information that will instruct the person how to access a video clip recording of what is to be displayed on the display 1 over the Internet. In the image and information database 16 the image file is then renamed with the unique ID assigned to the person for future identification (step S10). The matching processing module 12 then generates a text file (a personal information file) which contains personal information for a person (step S11). The text file is given the persons ID as the filename. The text file and the associated image file i.e. the files having the same ID as their filename prefix (i.e. ID.jpg and ID.txt) are transmitted by the transmission processing module 17 to the display computer system 4.

A receiving processing module 20 in the display computer system 4 waits to receive a personal information file and the associated image file (ID.jpg and ID.txt) from the kiosk computer system 6 (step S20 of FIG. 6a) and this is stored in the data store 21. If the approval mode is selected (step S21) an operator can use the user interface 22 under the control of the approval processing module 23 to display the picture to approve or disapprove the display of the picture on the display 1 (step S22). If the picture is not approved (step S23), a rejection notice is sent to the kiosk computer system 6 and the personal information file and image file are deleted (step S24). If the picture is approved (step S23), a flag is set to show that the picture is approved (step S25). The green processing module 24 looks for any image files in the data store 21 that have been flagged as approved. Any such files are read and processed by the green processing module 24 (step S26). The processing comprises a standard technique for subtracting the background green colour. The processing can also select a part of the person e.g. their face or head. Prior art software such as Photoshop can perform such a function. The result is a Targa (TGA) file having a key signal (an α channel) denoting a transparent background for each image file. This is stored in the TGA data store 25. The TGA file is given the filename ID.TGA so as to be uniquely identified for a person. Once processed, the image file has its approved flag deleted to avoid reprocessing by the green processing module 24 and the scheduler 26 puts the picture (the TGA file) in the display queue (step S27). The scheduler 26 controls the real-time processor 30 and the non real-time processor 27 to play the next animation or video clip at the next timeslot (step S28). If the next scheduled animation or video clip is not a vignette (i.e. a video clip or animation to which the picture of a person is to be superimposed) (step S29) the scheduler 26 controls the non-real-time processor 27 to retrieve the scheduled animation or video clip from the library of animations 28 i.e. retrieve an AVI file and process the retrieved file to render and output a VGA type signal (step S30). The control switch 29 is also controlled by the scheduler 26 to switch to output the VGA type signal from the non-real-time processor 27. The VGA type signal is thus output to the display controller 2 for display on the display 1 (step S31). In this way non-real-time animations or video clips that are scheduled for a time slot can be displayed on the display during the scheduled timeslot.

If the next scheduled animation or video clip is a vignette (step S29), the identity of the vignette is sent to the real-time processor 30 (step S33 of FIG. 6b). The switch 29 is also controlled by the scheduler 26 to switch to output to the display controller 2 the output of the real-time processor 30 (step S34). The real-time processor is controlled by the scheduler 26 to read the next image data file from the TGA data store 25 and to read the file, e.g. an AVI file from the library of animations 31, which includes path information, i.e. a position for each frame of the video at which the picture of the person is to be superimposed. Thus the real-time processor reads the animations from the library 31 and the images from the TGA data store 25 and performs a rendering process to superimpose the image of the person onto the animation to generate, in real-time, a VGA type output to the switch 29 (step S35). The switch 29 thus sends the VGA type output to the display controller 2 which controls the display 1 to display the real-time VGA (step S36).

The scheduler 26 also controls a VGA to video converter 32 to convert the VGA type output from the real-time processor 30 into a video output (step S37) which is received by the encoder 33 which encodes the video as a AVI file which is given the file name ID.AVI to enable it to be uniquely identified as the video associated with a person (step S38). The AVI file is then stored in a AVI store 34 (step S39) which can be accessed by a web server to allow the person to access and download the AVI file.

It can be seen in this embodiment that the scheduler enables either real-time or non-real-time animations to be output to the display 1 in accordance with a predetermined schedule. The non-real-time animations may comprise pre-recorded advertising animations, whereas the real-time animations include the image of a person superimposed onto the animation.

As illustrated in FIGS. 2a to 2d, the display can include a real-time clock permanently displayed in a portion of the display. In order to achieve this, in this embodiment of the present invention, the display controller 2 can include a separate clock computer for the generation of the clock display accurately synchronized to local time. This is the time that is used by the scheduler to schedule the displaying of the animations.

The library of animations 28 can include animations for geographic locations, e.g. London, Paris, etc. If the display is located in New York, the clock display area will display the local time in New York, and animations for e.g. London and Paris can include images of local clocks, e.g. Big Ben in London. In order to ensure that when the image of Big Ben in London is shown, the time shown on Big Ben corresponds to the local time, i.e. five hours ahead, the scheduler schedules the animation to be shown at the correct local time so that the time shown in the clip on Big Ben is five hours ahead of the time shown in the clock display region of the display 1.

Although in this embodiment of the present invention, the video clip made available to the member of the public is a copy of the video clip as actually displayed on the display 1, it is possible as an alternative or an addition to provide another camera, either a still digital camera or a video digital camera to take a picture of the display 1 and its surroundings, e.g. the Times Square region in which the display is positioned. The image provided by the camera can then be made available to the member of the public, e.g. stored in the AVI store 34 or e-mailed to the member of the public, i.e. sent to an e-mail address supplied by the member of the public. This feature provides the added benefit for the person of proving that their image was actually displayed publicly, e.g. in Times Square.

Although the present invention has been described hereinabove with reference to specific embodiments, it will be apparent to a skilled person in the art that modifications lie within the spirit and scope of the present invention. For example, although in the embodiment a digital camera 10 is provided to take a digital image or a digital video of the person 7, the present invention encompasses any means by which an image of a person can be input to the computer system. For example, it is possible that a person could bring a photograph of themselves to the booth and the photograph could be scanned. Alternatively, a photograph could be sent electronically, e.g. by e-mail to the computer system for incorporation into the display. The display can be a still image or a moving image and a still or moving image of the person can be superimposed on a still of moving advertising image.

In the present invention the term video when described with regard to video images, encompasses any form of moving pictures taken of the person. The present invention encompasses any form of still or video-type pictures that can be used to be superimposed on any other type of still or moving video pictures.

Although a specific embodiment has been described hereinabove with reference to specific processing modules, the present invention is not limited to any specific structure. The present invention can be implemented either in dedicated hardware or using general-purpose computers suitably programmed. Thus in such an implementation, the modules described hereinabove can be implemented as modules of code. The description of the various modules is merely given to illustrate the function of the apparatus and in no way limits the structure of the apparatus. Any modules described hereinabove could be implemented in combination or separately in computer code. In practice, many of the modules will comprise a single computer program. Similarly, with regard to the data stores and databases, these are shown separately in order to illustrate the embodiment of the present invention. However, in practice, these can be provided on any suitable storage medium and can in fact be provided in a number of storage media.

What is claimed is:

1. A method of advertising a product or service comprising:
taking a picture or video of a person;
inputting the picture or video into an image processing system;
superimposing the picture or video of the person onto a picture or video advertising a product or service in the image processing system to generate a composite picture or video; and
displaying the composite picture or video on an advertising display.

2. A method according to claim 1, including editing the picture or video of the person in the image processing system to remove the background before superimposition on a picture or video advertising a product or service.

3. A method according to claim 1, wherein the picture is taken of the person in the vicinity of the advertising display.

4. A method according to claim 1, wherein the picture or video of the person is superimposed in a predetermined position onto the picture or video advertising a product or service in the image processing system.

5. A method according to claim 4, wherein, in the image processing system, the picture or video of the person is superimposed onto a video advertising a product or service in a predetermined position in the video such that the position tracks a position relative to a moving object in the video.

6. A method according to claim 1, wherein a library of pictures or video recordings advertising products or services are provided and one of the library of pictures or video recordings is selected for the picture or video of the person to be superimposed onto to generate a composite picture or video.

7. A method according to claim 1, wherein the picture or video of the person is edited in the image processing system so as to only include the head of the person, and the head is superimposed onto the picture or video advertising a product or service in a position of an original head and with corresponding dimensions so as to replace the original head with the head of the person.

8. A method according to claim 1, wherein the displayed composite picture or video is made available to the person.

9. A method according to claim 8, wherein the displayed composite picture is stored so as to be accessible over the Internet to the person.

10. A method according to claim 8, including sending a copy of the composite picture of video to an email address provided by the person.

11. A method according to claim 1, including obtaining personal information from the person and storing the personal information.

12. A method according to claim 1, including taking a picture or video of the display and its surroundings during the display of the composite picture of video and providing the person with a copy.

13. A method according to claim 12, wherein the picture or video of the display and its surroundings is made available to the person over the Internet.

14. A method according to claim 12, wherein picture or video of the display and its surroundings is sent to an email address provided by the person.

15. A method according to claim 1, including manually reviewing the picture or video of the person to approve the picture or video for superimposition.

16. A method according to claim 1, wherein a plurality of pictures or videos of persons are stored, a library of pictures or video recordings advertising products or services are provided, and one of the library of pictures or video recordings is selected and one of the pictures or videos of the persons is selected for superimposition to generate a composite picture or video for display.

17. A method according to claim 16, wherein the selections are made in accordance with a predetermined schedule so that the composite pictures or videos are displayed in accordance with the schedule.

18. A method according to claim 17, including a second library of pictures or videos advertising products or services, wherein the schedule includes pictures or videos in the second library so that the pictures or videos are displayed in accordance with the schedule.

19. An advertising system for advertising a product or service, the system comprising:
a digital camera for taking a picture or video of a person;
a picture or video store storing a picture or video advertising a product or service;
an image processing system for coupling to the digital camera to receive the pictures or video of the person, and for superimposing the picture or video of the person onto the picture or video advertising a product or service to generate a composite picture or video; and
an advertising display for displaying the composite picture or video.

20. An advertising system according to claim 19, wherein the image processing system is arranged to edit the picture or video of the person to remove the background before superimposition on a picture or video advertising a product or service.

21. An advertising system according to claim 19, wherein the camera is provided in the vicinity of the advertising display.

22. An advertising system according to claim 19, wherein the image processing system is arranged to superimpose the picture or video of the person in a predetermined position onto the picture or video advertising a product or service.

23. An advertising system according to claim 22, wherein the image processing system is arranged to superimpose the picture or video of the person onto a video advertising a product or service in a predetermined position in the video such that the position tracks a position relative to a moving object in the video.

24. An advertising system according to claim 19, including a store storing a library of pictures or video recordings advertising products or services, and the image processing means is arranged to select one of the library of pictures or video recordings for the picture or video of the person to be superimposed onto to generate a composite picture or video.

25. An advertising system according to claim 19, wherein the image processing system is arranged to edit the picture or video of the person so as to only include the head of the person, and to superimpose the head onto the picture or video advertising a product or service in a position of an original head and with corresponding dimensions so as to replace the original head with the head of the person.

26. An advertising system according to claim 19, including storing the displayed composite picture or video so as to be available to the person.

27. An advertising system according to claim 26, wherein the displayed composite picture is stored so as to be accessible over the Internet to the person.

28. An advertising system according to claim 26, including an email processor system for sending a copy of the composite picture of video to an email address provided by the person.

29. An advertising system according to claim 19, including a user interface for obtaining personal information from the person and an information store for storing the personal information.

30. An advertising system according to claim 19, including a second camera for taking a picture or video of the display and its surroundings during the display of the composite picture of video, and an image store for storing the picture or video so as to be available to the person.

31. An advertising system according to claim 30, wherein picture or video of the display and its surroundings is stored so as to be available to the person over the Internet.

32. An advertising system according to claim 30, including an email processing system for sending the picture or video of the display and its surroundings to an email address provided by the person.

33. An advertising system according to claim 19, including manually reviewing the picture or video of the person to approve the picture or video for superimposition.

34. An advertising system according to claim 19, including an image store storing a plurality of pictures or videos of persons, and a library store storing a library of pictures or video recordings advertising products or services, wherein the image processing system is arranged to select one of the library of pictures or video recordings and one of the pictures or videos of the persons for superimposition to generate a composite picture or video for display.

35. An advertising system according to claim 34, wherein the image processing system is arranged to make the selections in accordance with a predetermined schedule so that the composite pictures or videos are displayed in accordance with the schedule.

36. An advertising system according to claim 35, including a second library store storing a second library of pictures or videos advertising products or services, wherein the image processing system is arranged to include in the schedule pictures or videos in the second library so that the pictures or videos are displayed in accordance with the schedule.

37. An advertising system for advertising a product or service, the system comprising:
input means for inputting a digital picture or video of a person;
storing means for storing a picture or video advertising a product or service;
image processing means for receiving the digital pictures or video of the person, and for superimposing the picture or video of the person onto the picture or video advertising a product or service to generate a composite picture or video; and
output means for outputting the composite picture or video for display.
